(19) United States
(12) Patent Application Publication
(10) Pub. No.: US 2021/0103269 A1
(43) Pub. Date: Apr. 8, 2021

(54) METHODS, SYSTEMS, APPARATUSSES AND DEVICES FOR FACILITATING PRODUCING HOLLOWED 3D SHAPES BY LAYER

(71) Applicants: Hans Thomas Landsberger, Edinburgh (GB); Nathaniel Tyan Burn, Mercer Island, WA (US)

(72) Inventors: Hans Thomas Landsberger, Edinburgh (GB); Nathaniel Tyan Burn, Mercer Island, WA (US)

(21) Appl. No.: 17/054,571

(22) PCT Filed: Jun. 13, 2019
(86) PCT No.: PCT/IB2019/054974

§ 371 Date: Nov. 11, 2020

Related U.S. Application Data
(60) Provisional application No. 62/684,603, filed on Jun. 13, 2018.

(51) Int. Cl. G05B 19/4099; B33Y 50/02; B29C 64/393; B33Y 80/00

(52) U.S. Cl. CPC G05B 19/4099; B33Y 50/02; G05B 2219/49023; B33Y 80/00; B29C 64/393

(57) ABSTRACT

Disclosed herein is a system for producing hollowed 3D shapes by layer. Further, the system may include a communication device configured for receiving a contour information corresponding to a contour, and transmitting an effective inner contour to a construction device. Further, the system may include a processing device configured for forming a plurality of regular geometric shapes around a plurality of sample points corresponding to the contour, forming a plurality of projections corresponding to the plurality of regular geometric shapes onto a printing plane, and superimposing the plurality of projections to obtain the effective inner contour.

### FIELD OF THE INVENTION

The present invention relates generally to the field of data processing. More specifically, the present disclosure relates to methods, systems, apparatuses and devices for facilitating producing hollowed 3D shapes by layer.

### BACKGROUND OF THE INVENTION

For consumer applications of additive manufacturing or 3D printing, it is common that the objects to be printed are defined in terms of their outer shape. It is up to the user, through the use of print preparation software, to determine how the object should be printed. This gives the user control over aspects such as object size, mass, mechanical strength, print time, and total print cost.

Most 3D objects printed by consumers and artisans are produced as hollowed shapes that are computationally derived from the shape of the outer hull. An optional “infill” structure is often added through further features in the software in order to save material, mass, and print time while preserving strength. The method of hollowing employed by typical consumer 3D printing software is computationally simple but produces walls whose thickness and strength are strongly dependent on the inclination of the outer hull relative to the orientation of the layers of deposition in the additive manufacturing device. In order to compensate for the variation in mechanical strength, the walls are then made thicker than they would otherwise need to be, and the infill denser, leading to sub-optimal uses of both print time and material. Computer Aided Design (CAD) systems employ various methods to create precisely defined walls on objects, using the geometric definition of the outer hull as input. One such method is offset surface calculation, in which small patches of the outer surface are projected (offset) inward, and self-intersections of that offset surface are subsequently removed [JSC04]. Another common approach is that of the union of balls, in which a set of surface sample points is each surrounded with a sphere having a radius equal to the desired wall thickness. The surface of the inner hull is then formed by the 3D Boolean union of these spheres [WM13]. Yet another method samples a distance field of the surface and applies a contouring algorithm to construct the offset surface [LW11].

However, traditional computational methods of additive manufacturing including surface -construction are computationally expensive, requiring powerful computer hardware and/or long execution time to perform the wall construction task. The computational cost makes these methods too expensive for consumer applications.

Therefore, there is a need for improved methods, systems, apparatuses and devices for facilitating producing hollowed 3D shapes by layer that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A method for producing hollowed 3D shapes by layer is disclosed. Further, the method may include receiving, using a communication device, a contour information corresponding to a contour of a 3D shape. Further, the method may include forming, using the processing device, a plurality of regular geometric shapes around a plurality of sample points corresponding to the contour. Further, the method may include forming, using the processing device, a plurality of projections corresponding to the plurality of regular geometric shapes onto a printing plane. Further, the method may include superimposing, using the processing device, the plurality of projections to obtain an effective inner contour corresponding to the contour of the 3D shape. Further, the method may include transmitting, using the communication device, the effective inner contour to a construction device for constructing the shape.

Further, a method for producing hollowed 3D shapes by layer is disclosed. Further, the method may include receiving, using a communication device, a geometrical data file corresponding to a 3D shape to be printed from a source. Further, the method may include slicing, using a processing device, the 3D shape. Further, the slicing may include analyzing the 3D shape to determine a contour. Further, the method may include forming, using the processing device, a plurality of regular geometric shapes around a plurality of sample points corresponding to the contour. Further, the method may include forming, using the processing device, a Boolean union of a plurality of projections corresponding to the plurality of regular geometric shapes onto a printing plane to obtain a shape corresponding to an inner contour. Further, the method may include superimposing, using the processing device, the shape to obtain an effective inner contour corresponding to the contour of the 3D shape. Further, the superimposing may include forming a Boolean union of the shape. Further, the method may include transmitting, using the communication device, the effective inner contour to a construction device for constructing the 3D shape.

Further disclosed herein is a system for producing hollowed 3D shapes by layer. Further, the system may include a communication device configured for receiving a contour information corresponding to a contour of a 3D shape. Further, the communication device may be configured for transmitting an effective inner contour to a construction device for constructing the shape. Further, the system may include a processing device configured for forming a plurality of regular geometric shapes around a plurality of sample points corresponding to the contour. Further, the processing device may be configured for forming a plurality of projections corresponding to the plurality of regular geometric shapes onto a printing plane. Further, the processing device may be configured for superimposing the plurality of projections to obtain the effective inner contour corresponding to the contour of the 3D shape.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

FIG. 1 is a block diagram representation of a first portable electronic device for facilitating a proximity based interaction with a second portable electronic device based on a plurality of gestures, in accordance with some embodiments.

FIG. 2 is a block diagram of a system for producing hollowed 3D shapes by layer, in accordance with some embodiments.

FIG. 3 is a flowchart of a method for producing hollowed 3D shapes by layer, in accordance with some embodiments.

FIG. 4 is a flowchart of a method of determining the contour in accordance with some embodiments.

FIG. 5 is a flowchart of a method of removing an unconstructible detail from the contour, in accordance with some embodiments.

FIG. 6 is a flowchart of a method of adding construction material at one or more stress points of a 3D shape, in accordance with some embodiments.

FIG. 7 is a flowchart of a method for producing hollowed 3D shapes by layer, in accordance with some embodiments.

FIG. 8 is a block diagram of a hardware and software system for layered manufacturing in accordance with some embodiments.

FIG. 9 is a flowchart of a method including a plurality of steps performed by the print preparation system, in accordance with some embodiments.

FIG. 10 is a representation of a simple object, a twisted cube, which provides a basic exemplary shape, in accordance with some embodiments.

FIG. 11 is an outer hull contour at an arbitrary horizontal cross-section (layer) of the simple object, in accordance with some embodiments.

FIG. 12 is a representation of an ideal geometric shape of the toroidal projection of the simple object, converted into slices coinciding with the layers of material deposition, in accordance with some embodiments.

FIG. 13 shows three sliced layers with the projections around outer hull contours, in accordance with some embodiments.

FIG. 14 is a representation of a successively denser set of superimposed projections forming a shape of shape an inner hull of the simple object, in accordance with some embodiments.

FIG. 15 is a representation of projections of a top face, and a bottom face of the simple object, in accordance with some embodiments.

FIG. 16 is a depiction of the outer hull contour of a single layer of the simple object, in accordance with some embodiments.

FIG. 17 is an illustration of forming of a Boolean union of a plurality of spherical projections centered on a plurality of points on the outer hull contour through their sliced contours, which may be circular, in accordance with some embodiments.

FIG. 18 is a completed Boolean union of the plurality of spherical projections, in accordance with some embodiments.

FIG. 19 is a representation of a superposition of a projection from a neighboring layer, in accordance with some embodiments.

FIG. 20 is a cross-section of a wall that may result from a Boolean intersection of the superposition enclosed by the outer hull contour, in accordance with some embodiments.

FIG. 21 is a resulting inner hull contour derived from the cross-section of the wall, in accordance with some embodiments.

FIG. 22 is a representation of a superimposition of oriented inner projection contours, in accordance with some embodiments.

FIG. 23 is a representation of an enlarged view of the superimposition, after resolution of the intersection, in accordance with some embodiments.

FIG. 24 is a representation of an inner hull the superimposition, in accordance with some embodiments.

FIG. 25 is a vertical cross-section of an object to illustrate the forming of a wall of uniform thickness around a concave region of the hull in accordance with some embodiments.

FIG. 26 is an exemplary offset projection profile to produce uniform or variable wall thickness, in accordance with some embodiments.

FIG. 27 is a complex object, in accordance with some embodiments.

FIG. 28 is a second orientation of the complex object, in accordance with some embodiments.

FIG. 29 is an outer hull trace of the object at a vertical level, in accordance with some embodiments.

FIG. 30 is a representation of an inward offset of the outer hull trace at a constant offset distance, in accordance with some embodiments.

FIG. 31 is a representation of a plurality of projected offsets from surrounding layers superimposed on the inward offset, in accordance with some embodiments.

FIG. 32 is a representation of the outer hull and a plurality of profiles of the computed inner hull of the object, in accordance with some embodiments.

FIG. 33 is a representation of a layer of an object along with a stress points that may need to be reinforced, in accordance with some embodiments.

FIG. 34 is a representation of an initial wall offset projections in the layer, in accordance with some embodiments.

FIG. 35 is a representation of a plurality of slices and of a reinforcement material superimposed on the initial wall offset projections, in accordance with some embodiments.

FIG. 36 is a representation of a Boolean union of the plurality of slices and the initial wall offset projections, in accordance with some embodiments.

FIG. 37 is a representation of a wall resulting from the Boolean intersection, in accordance with some embodiments.

FIG. 38 is an inner hull contour derived from the wall resulting from the Boolean intersection, in accordance with some embodiments.

FIG. 39 is an inner hull contour derived using the simplified wall projection method in accordance with some embodiments.

FIG. 40 is a reinforcement using simplified hollowing method, in accordance with some embodiments.

FIG. 41 illustrates how a multi-layered (sandwiched) wall may be constructed, in accordance with some embodiments.

FIG. 42 shows a layer, hollowed three times, with the spaces between the concentric hulls filled, in sequence, with solid material, light-weight lattice structure, and again with solid material, in accordance with some embodiments.

FIG. 43 shows the layer hollowed three times to produce a sandwiched wall structure along with identification of two stress points having reinforced, in accordance with some embodiments.

FIG. 44 is a block diagram of a computing device for implementing the methods disclosed herein, in accordance with some embodiments.

Furthermore, the drawings may contain text or captions that may explain certain embodiments of the present disclosure. This text is included for illustrative, non-limiting, explanatory purposes of certain embodiments detailed in the present disclosure.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of producing hollowed 3D shapes by layer, embodiments of the present disclosure are not limited to use only in this context.

Overview:

A geometric processing system is described herein for efficiently hollowing geometries with a precisely controlled, uniform or varying wall thickness. The disclosure describes a method for hollowing that requires significantly fewer computational resources than the prior art, in terms of both processor time and memory used. Furthermore, the method significantly reduces the need for over-dimensioning of walls, infill, and support structures. As a result, it also reduces manufacturing cost in terms of both time and material.

The method is applicable to any additive manufacturing technology in which material is deposited in layers, such as 3D printing methods or the assembly of cut sheets. The general concept of the invention is described first, as well as the preferred implementation which is especially efficient in terms of computational resources.

In one implementation, the processing system operates by receiving an input geometry of any type and from any source. For example, the input geometry may consist of a triangular mesh defined in a stereo lithography (STL) file, a common file format for 3D applications. The processing system then imports that geometry into an assembly of objects to be printed and allows the user to define parameters such as print scale, wall thickness, and infill characteristics. Thereafter, the processing system creates a set of per-layer contours which define the extent of the material deposition by the additive manufacturing device. When these layers are deposited one on top of the other, the resulting object has walls with prescribed thickness, independent of their orientation during deposition.

In another implementation, the wall thickness can be varied across the printed object, through manual or programmatic means, to optimize its physical characteristics.

For example, regions of high mechanical stress, such as inward creases of the surface, can be identified, and the wall can be reinforced (thickened) around them. According to another illustrative aspect, the processing system can produce sandwiched walls consisting of alternating layers of solid material and lighter infill containing cavities, allowing the automated construction of walls with high strength-to-weight ratio.

The above approach can be manifested in various types of systems, components, methods, computer readable storage media, data structures, graphical user interface presentations, articles of manufacture, etc.

Although the invention has been explained in relation to its preferred embodiment, it is to be understood that many other possible modifications and variations can be made without departing from the spirit and scope of the invention.

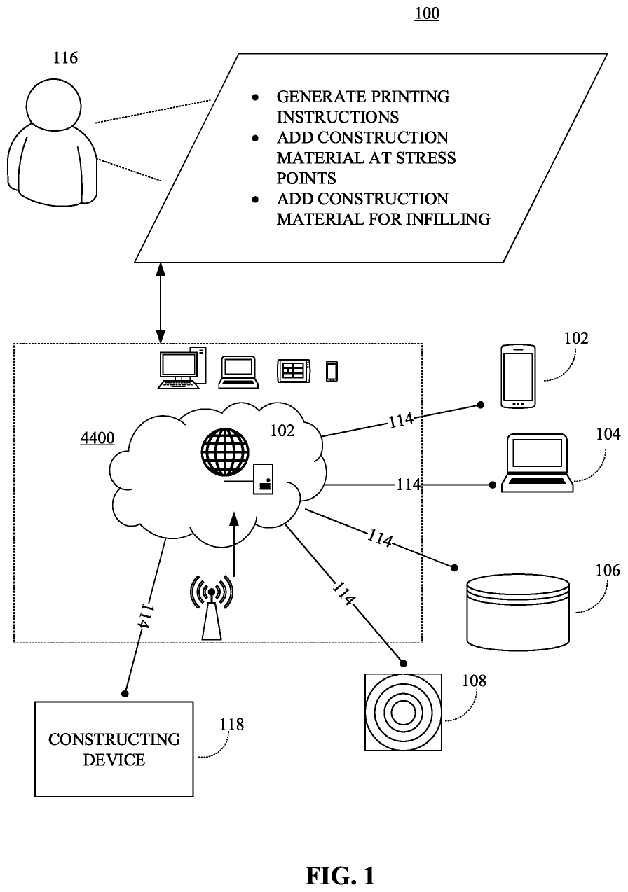

FIG. 1 is an illustration of an online platform 100 consistent with various embodiments of the present disclosure. By way of non-limiting example, the online platform 100 to facilitate producing hollowed 3D shapes by layer may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, sensors 110, and a construction device 118 (such as a 3D printer) over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 4400.

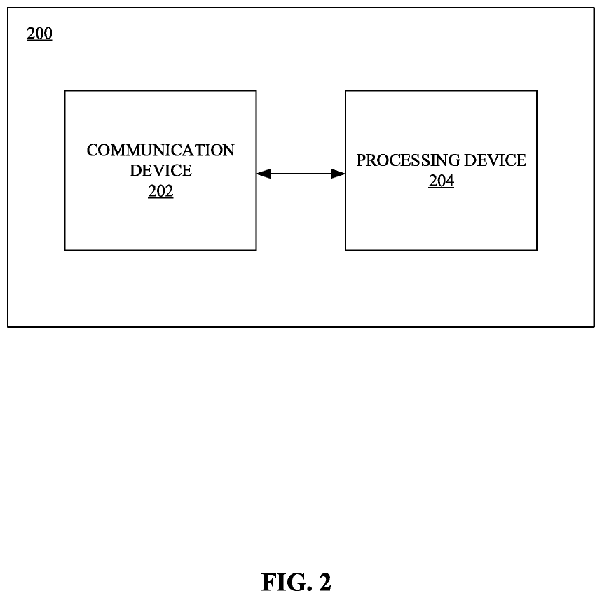

FIG. 2 is a block diagram of a system 200 for producing hollowed 3D shapes by layer, in accordance with some embodiments.

Further, the system 200 may include a communication device 202 configured for receiving a contour information corresponding to at least one contour of a 3D shape. Further, the communication device 202 may be configured for transmitting an effective inner contour to a construction device for constructing the shape.

Further, the system 200 may include a processing device 204 configured for forming at least one plurality of regular geometric shapes around at least one plurality of sample points corresponding to the contour.

Further, the processing device 204 may be configured for forming at least one plurality of projections corresponding to the plurality of regular geometric shapes onto the printing plane.

Further, the processing device 204 may be configured for superimposing the plurality of projections to obtain the effective inner contour corresponding to the contour of the 3D shape.

Further, in some embodiments, the communication device 202 may be configured for receiving a geometrical data file corresponding to the 3D shape from a source.

For instance, the geometric data file may include input a triangular mesh defined in a stereo lithography (STL) file or a common file format for 3D applications. Further, the source may include a local or remote repository of 3D models, a software program producing 3D models, a 3D scanner, or any other device or process designed to generate the geometric data file.

Further, the processing device 204 may be configured for slicing the 3D shape. Further, the slicing may include analyzing the 3D shape to determine the contour.

Further, the processing device 204 may be configured for importing that geometric data file into an assembly of objects to be printed. Further, the communication device 202 may be configured for receiving user parameters such as print scale, wall thickness, and infill characteristics corresponding to the geometric data file.

Further, in some embodiments, the processing device 204 may be further configured for analyzing the contour information corresponding to the contour to determine at least one unconstructible detail, and removing the at least one unconstructible detail to generate a clean contour information corresponding to the contour. Further, the at least one unconstructible detail may include detail too small to be faithfully reproduced by the construction device. Further the removing of the unconstructible detail may prevent detail that may not printed on the outer surface by the construction device from appearing on the effective inner contour where the unconstructible detail may potentially get magnified by projection in concave sections.

Further, in some embodiments, a dimension of the plurality of regular geometric shapes may correspond to a thickness parameter of the 3D shape. For instance, if the plurality of regular geometric shapes includes a plurality of circles, a diameter of the plurality of circles may correspond to a thickness parameter of one or more walls of the 3D shape.

Further, in some embodiments, the processing device 204 may be configured for defining a thickness parameter corresponding to each of the contour and the effective inner contour.

Further, the processing device 204 may be configured for generating at least one infill structure corresponding to an empty space between each of the contour and the effective inner contour.

Further, the communication device 202 is further configured for transmitting each of the thickness parameter, and the at least one infill structure to the construction device.

Further, in some embodiments, the processing device 204 may be configured for obtaining a plurality of effective inner contours congruent with the effective inner contour. Further, the processing device 204 may be configured for defining a thickness parameter corresponding to each of the contour and the plurality of effective inner contours. Further, the processing device 204 may be configured for generating at least one infill structure corresponding to an empty space between each of the plurality of effective inner contours. Further, the communication device 202 may be configured for transmitting each of the effective inner contours, the thickness parameter corresponding to each of the contour and the plurality of effective inner contours, and the at least one infill structure to the construction device.

Accordingly, the system 200 may be configured for creation of walls consisting of sandwiched layers of defined thickness, by the plurality of effective inner contours using multiple wall thicknesses. If a regular geometric is used, but at different scales, then these inner hulls will be concentric, and the spaces between them will have a constant distance. The spaces can then be filled with infill structures, such as lattices or origami-like folding structures, resulting in light-weight but high-strength walls. FIG. 41 is an exemplary cross-section of such a sandwiched wall is shown where an outer contour 4102 may be offset five times to form the five effective inner contours, including first effective inner contour 4104, second effective inner contour 4106, third effective inner contour 4108, fourth effective inner contour 4110, and fifth effective inner contour 4112. The space between the five effective inner contours may be alternately filled with solid material and a low-density lattice.

Further, in an instance, the processing device 204 may be configured for defining local reinforcements for at least one of the plurality of effective contours, including the first effective inner contour 4104, the second effective inner contour 4106, the third effective inner contour 4108, the fourth effective inner contour 4110, and the fifth effective inner contour 4112.

Further, in some embodiments, the plurality of regular geometric shapes may include 3D globular shapes, such as spheres, ellipsoids, and so on.

Further, in some embodiments, the construction device may include a 3D printer. Further, the plurality of regular geometric shapes corresponds to at least one printing plane.

Further, in some embodiments, a dimension of the plurality of regular geometric shapes may be configured to accommodate a varying thickness of the 3D shape.

Further, in some embodiments, the dimension of a first plurality of regular geometric shapes may be different from the dimension of a second plurality of regular geometric shapes. Further, the different dimensions of each of the first plurality of regular geometric shapes and the second plurality of regular geometric shapes may relate to a varying thickness parameter of the 3D shape.

Further, in some embodiments, the processing device 204 may be configured for analyzing the contour information to determine at least one stress point, and increasing a dimension of at least one regular geometric shape corresponding to at least one sample point corresponding to the at least one stress point.

Further, in some embodiments, the communication device 202 may be configured for receiving a geometrical data file corresponding to a 3D shape to be printed from a source. Further, the communication device 202 may be configured for transmitting an effective inner contour to a 3D printer for constructing the 3D shape.

Further, the processing device 204 may be configured for slicing the 3D shape. Further, the slicing may include analyzing the 3D shape to determine the contour. Further, a process of obtaining contours from the 3D shape may be called as slicing. Further, slicing layer may refer to a cross-section of the 3D shape that may be parallel to printing plane (layers of material deposition). Further, the contour may be represented in any closed form such as a polyline, a circular arc, a boundary, one or more splines, one or more freeform curves, and so on.

Further, in an instance, the contour may be approximated in 2D within a desired manufacturing tolerance, in order to reduce the complexity of all subsequent operations. For example, polylines may be simplified by using an approximation algorithm, or may be approximated by a circular arc boundary which may have a significantly smaller number of plurality of sample points. A 2D approximation may be faster than an approximation of the 3D shape like the decimation of a mesh geometry.

Further, the processing device 204 may be configured for forming at least one plurality of regular geometric shapes around at least one plurality of sample points corresponding to the contour.

Further, the processing device 204 may be configured for forming at least one Boolean union of the plurality of projections corresponding to the plurality of regular geometric shapes onto the printing plane to obtain a shape corresponding to an inner contour.

Further, the processing device 204 may be configured for superimposing, using the processing device 204, the shape to obtain the effective inner contour corresponding to the contour of the 3D shape. Further, the superimposing may include forming a Boolean union of the shape.

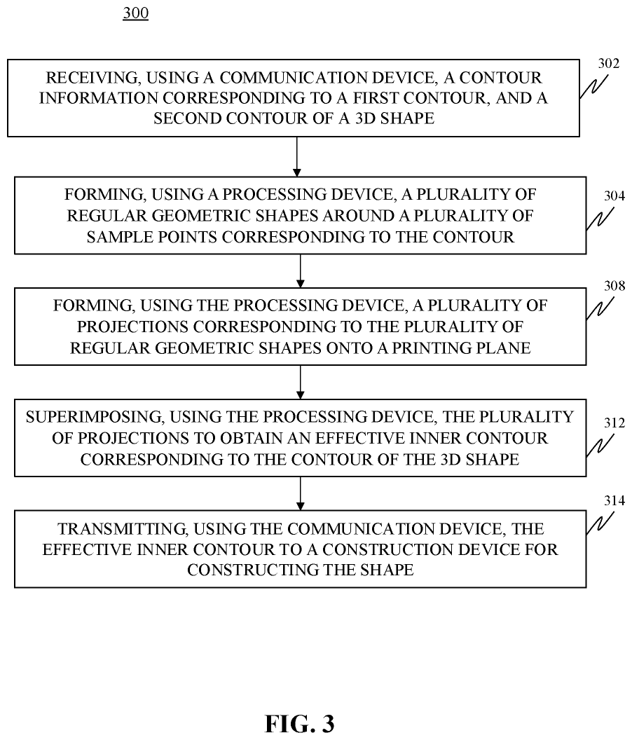

FIG. 3 is a flowchart of a method 300 for producing hollowed 3D shapes by layer, in accordance with some embodiments. Further, at 302, the method 300 may include receiving, using a communication device, a contour information corresponding to at least one contour of a 3D shape.

Further, at 304, the method 300 may include forming, using the processing device, at least one plurality of regular geometric shapes around at least one plurality of sample points corresponding to the contour. Further, in some embodiments, a dimension of the plurality of regular geometric shapes may correspond to a thickness parameter of the 3D shape.

Further, at 308, the method 300 may include forming, using the processing device, at least one plurality of projections corresponding to the plurality of regular geometric shapes onto the printing plane.

Further, at 312, the method 300 may include superimposing, using the processing device, the plurality of projections to obtain an effective inner contour corresponding to the contour of the 3D shape.

Further, at 314, the method 300 may include transmitting, using the communication device, the effective inner contour to a construction device for constructing the shape.

Further, in some embodiments, the plurality of regular geometric shapes may include 3D globular shapes.

Further, in some embodiments, the construction device may include a 3D printer. Further, the plurality of regular geometric shapes corresponds to at least one printing plane.

Further, in some embodiments, a dimension of each of the plurality of regular geometric shapes may be configured to accommodate a varying thickness parameter of the 3D shape.

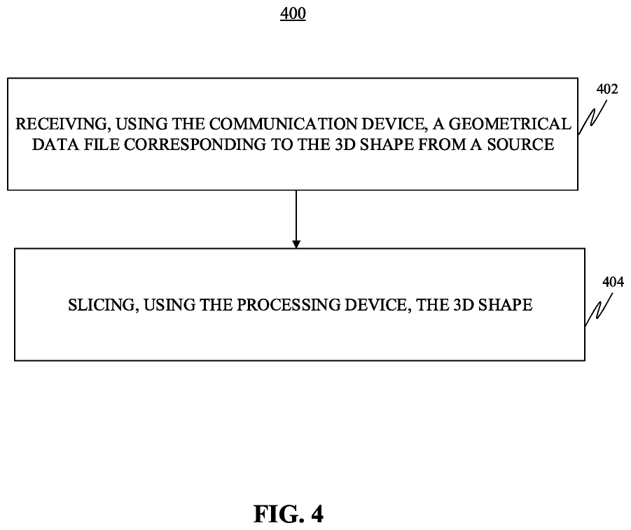

FIG. 4 is a flowchart of a method 400 of determining the contour in accordance with some embodiments. Further, at 402, the method 400 may include receiving, using the communication device, a geometrical data file corresponding to the 3D shape from a source.

Further, at 404, the method 400 may include slicing, using the processing device, the 3D shape. Further, the slicing may include analyzing the 3D shape to determine the contour.

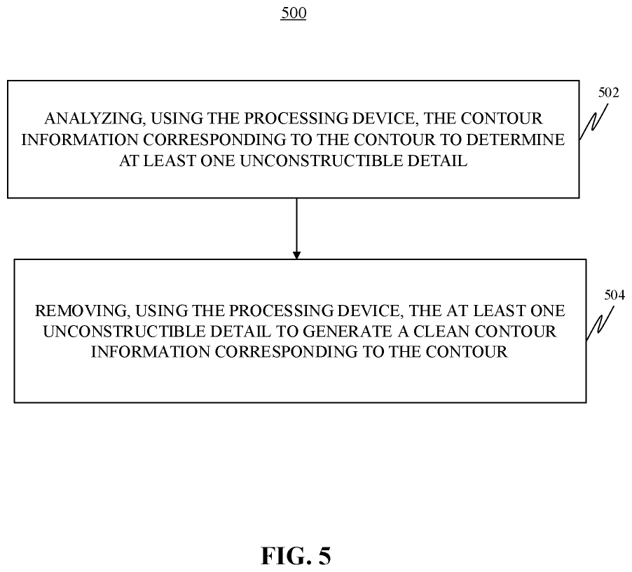

FIG. 5 is a flowchart of a method 500 of removing an unconstructible detail from the contour, in accordance with some embodiments.

Further, at 502, the method 500 may include analyzing the contour information corresponding to the contour to determine at least one unconstructible detail.

Further, at 504, the method 500 may include Further, the method may include removing, using the processing device, the at least one unconstructible detail to generate a clean contour information corresponding to the contour.

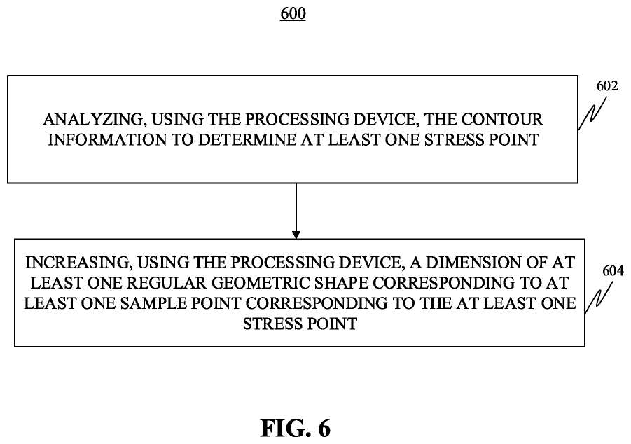

FIG. 6 is a flowchart of a method 600 of adding construction material at one or more stress points of a 3D shape, in accordance with some embodiments.

Further, at 602, the method 600 may include analyzing, using the processing device, the contour information to determine at least one stress point.

Further, at 604, the method 600 may include increasing, using the processing device, a dimension of at least one regular geometric shape corresponding to at least one sample point corresponding to the at least one stress point.

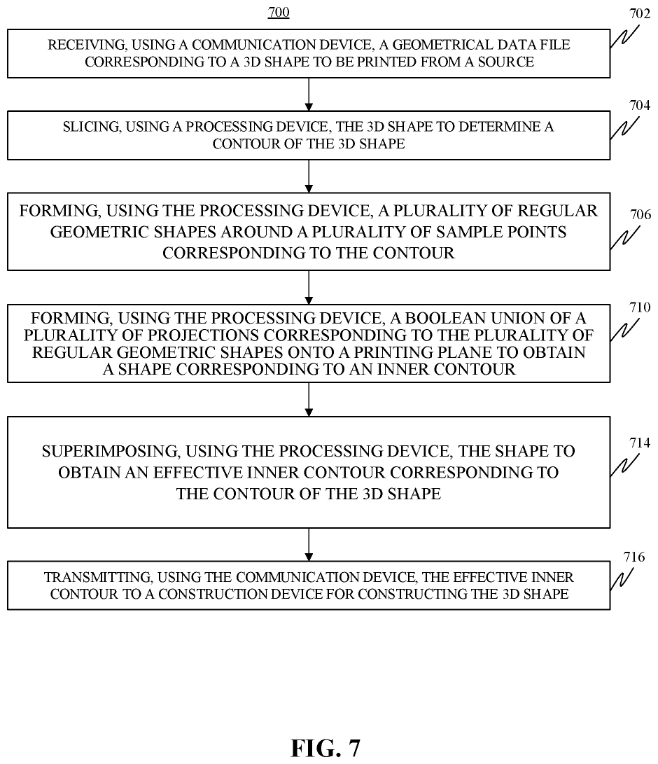

FIG. 7 is a flowchart of a method 700 for producing hollowed 3D shapes by layer, in accordance with some embodiments.

Further, at 702, the method 700 may include receiving, using a communication device, a geometrical data file corresponding to a 3D shape to be printed from a source. Further, at 704, the method 700 may include slicing, using a processing device, the 3D shape to determine at least one contour of the 3D shape.

Further, at 706, the method 700 may include forming, using the processing device, at least one plurality of regular geometric shapes around at least one plurality of sample points corresponding to the contour.

Further, at 710, the method 700 may include forming, using the processing device, at least one Boolean union of at least one plurality of projections corresponding to the plurality of regular geometric shapes onto the printing plane to obtain a shape corresponding to an inner contour.

Further, at 714, the method 700 may include superimposing, using the processing device, the shape to obtain an effective inner contour corresponding to the contour of the 3D shape. Further, the superimposing may include forming a Boolean union of the shape.

Further, at 716, the method 700 may include transmitting, using the communication device, the effective inner contour to a construction device for constructing the 3D shape.

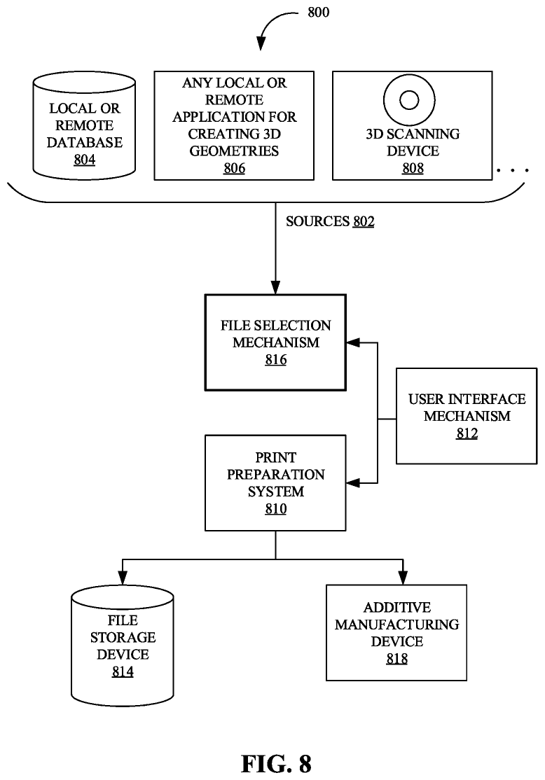

FIG. 8 is a general structure of a hardware and software system 800 for layered manufacturing in accordance with some embodiments. Components of the system 800 may form an integrated whole, or may be distributed across different devices, locations, and services, including repositories and services on the internet. The components shown in FIG. 8 are intended to be purely illustrative, by way of example, not limitation. 3D information describing the geometry of one or more objects to be 3D printed or otherwise manufactured may be supplied by one or more data sources 802, which may include a local or remote repository of 3D models 804, a software program producing 3D models 806, a 3D scanner 808, or any other device or process designed to generate 3D information. A print preparation system 810 may convert the 3D information into instructions required by the layered manufacturing device 818 to create a physical instance of the one or more objects specified by the user. Further, the layered manufacturing system 818 may include manufacturing systems to facilitate at least one of fused filament fabrication, stereo lithography, digital light processing (DLP), laser sintering, laser melting, binder jetting, electric arc deposition, or laminated construction with cut sheets. Further, the system may include a file selection mechanism 816, a user interface mechanism 812, and a file storage device 814.

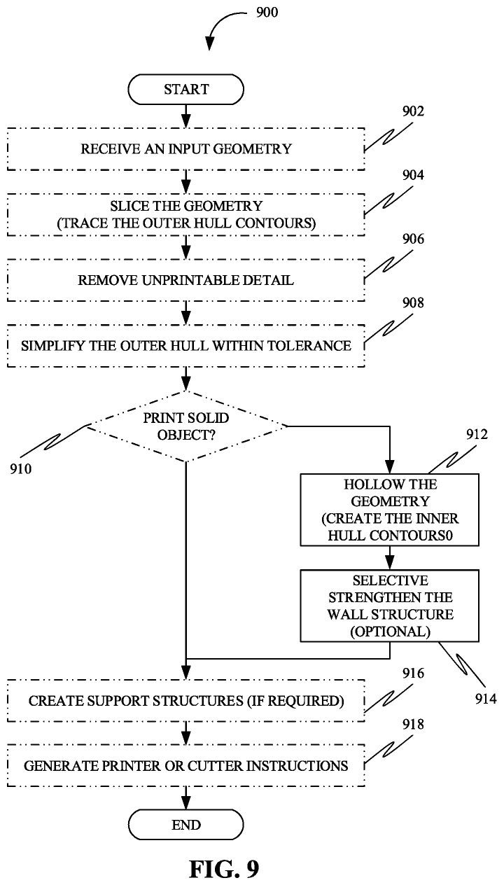

FIG. 9 is a flowchart of a method 900 including a plurality of steps performed by the print preparation system 810, in accordance with some embodiments. Further, FIG. 8 and FIG. 9 may serve as examples only, without any assumption of generality or completeness.

At 902, the method 900 includes receiving an input geometry. At 904, the method 900 includes slicing the geometry (trace the outer hull contours). At 906, the method 900 includes removing unprintable detail. At 908, the method 900 includes simplifying the outer hull within tolerance. At 910, the method 900 includes determining if solid object is to be printed.

Based on determination at 910, at 912, the method 900 includes hollowing the geometry (creating the inner hull contours). At 914, the method 900 includes selectively strengthening the wall structure (optional). At 916, the method 900 includes creating support structures (if required). At 918, the method 900 includes generating printer or cutter instructions.

Depending on the type of 3D data source and the process with which the data may have been generated, the 3D information may contain information about the interior of the object, including the thickness of walls, or may describe an outer hull of the object only. In either case a user may prefer to manufacture the object on a construction device (e.g. a 3D printer) hollowed to the user's specification, in order to save material, weight, or print time, or to control strength or other properties of the object. To this end, typical print preparation systems provide a “hollowing” functionality which derives the structure of the interior from the given outer hull geometry. Alternatively, the hollowing capability could be provided as a service to complement the print preparation process implemented by others. In purely geometric terms, the definition of the inner hull of a hollowed object may be formed by projecting, or offsetting, the outer hull inwards in the direction of the surface normal, by a distance equal to the desired wall thickness, such as by following a 3-step process including forming 3D projections centered around an infinitely dense set of sample points on the surface (outer hull) of the object, forming Boolean union of the projections, and taking Boolean intersection of a shape created by forming Boolean union with a space enclosed by the outer hull. An inner surface of the resulting shape may be the sought inner hull of the hollowed object. For layered manufacturing, the inner hull may be then traced to obtain a contour in each layer of deposition. Further, if the projections are uniform spheres, the walls will have a uniform thickness equal to the radius of the spheres. Conceptually, the method described here performs such a sequence of operations including the contour trace. The spacing of the employed sample points for the projections is infinitely dense within each slicing layer and equal to the layer spacing, also referred to as the printing resolution, in the perpendicular (usually vertical) dimension.

The key to significantly reducing the number of calculations compared to other methods lies in the fact that the method creates the inner hull in the form of per-layer contours. This is efficient because the contours are the representation typically expected by the next stage of a geometry processing pipeline for layered manufacturing. It also obviates the need for the creation of an intermediate 3D representation of the inner hull whose contours would then be traced. This approach allows all necessary transformations to be performed as 2D operations on curves, and those are computationally much simpler than 3D operations.

The input to the hollowing process consists of the contours of the outer hull at each level of material deposition, which are typically generated in an early processing step in 3D print preparation systems. The process of obtaining contours from a 3D shape is often called “slicing”, and the term “slicing layer” then refers to a cross-section of the 3D object that is parallel to the layers of material deposition. The contours can be represented in any closed form commonly used, e.g. as a polyline, a circular arc boundary, splines, or freeform curves.

Any pre-processing of the contours to assure printability with the given manufacturing technology would be performed before hollowing. For example, detail too small to be faithfully reproduced by the printing equipment would be removed, and the resulting “cleaned” contours would form the input to the hollowing process. This will prevent detail that is not printed on the outer surface from appearing on the inner hull, where it might potentially even get magnified by projection in concave sections.

The contours can optionally be approximated in 2D within the desired manufacturing tolerance, in order to reduce the complexity of all subsequent operations. For example, polylines can be simplified by using an approximation algorithm like that described in [HB96], or they can be approximated by a circular arc boundary which typically has a significantly smaller number of points [G16]. A 2D approximation will typically be faster than an approximation of the 3D shape like the decimation of a mesh geometry as described in [GH97] but can nevertheless guarantee strict error bounds of the approximation.

Conceptually, for each layer, the 3D Boolean union of all the projections centered on the outer hull contour is then formed and sliced in each layer which it penetrates. The form of the sliced projection contours could be determined mathematically by forming the 2D Boolean union of the sliced contours of the 3D projections. For layers in which the surface of the object is nearly parallel to the plane of material deposition, i.e. layers with a plateau, that plateau has to be identified and projected into the surrounding layers as well. As can be seen in the simple example of a cube, the contours of the projections of the vertical faces, by themselves, cannot provide a complete description of the inner hull; the top and bottom faces need to be projected into the interior as well.

The shape of a plateau can be identified by taking the Boolean difference between the outer hull contours of the layer of interest and the layer below. If the radius of any maximal disk inscribed in this shape exceeds a threshold which indicates that spherical projections along the contour would form a depression in the center whose depth exceeds the desired tolerance of the inner hull, then the shape of the plateau is projected as a whole and these projections superimposed with those of the slicing contours.

The result of these Boolean operations is a set of offset curves in each sliced projection layer. For the common case of uniform wall thickness, which is obtained with a uniform spherical 3D projection with a radius of the desired wall thickness, one can visualize the overall projected 3D shape generated from a given layer or slice of the object geometry as a toroidal surface with the contour trace at its poloidal center. In other words, a cylindrical extrusion is formed along the outer hull contour. This shape is then sliced at all deposition layers that it intersects, and those slices will be combined with projections from other layers.

The sliced offset curves can be constructed by offsetting the outer hull contour outwards and inwards within the generating layer and translating the result into the sliced projection layer. In the simple case of uniform selected wall thickness, the offset curves have a constant offset distance within each projection layer in this case; that distance is equal to the wall thickness in the generating layer and gets smaller with the vertical distance. (Due to the symmetry of the torus, the offset curves on both sides of the generating plane are identical, so they only need to be computed once.) In the more complex case where variations in wall thickness have been selected, the offset distance will vary within each projection layer, symmetries may not exist, and inner and outer sliced offset contours may merge into a single contour.

Curve offsetting can be performed with any of the well-established methods, as applicable to the format of the input contour, e.g. offsetting using the Voronoi diagram [H98] or the distance from the 2D medial axis [PF10], offsetting by computing winding numbers [CM05], or various methods for offsetting freeform curves [ELK97]. The same methods can be applied to any projection which has a circular cross-section centered around the normal of the projecting point when sliced parallel to the generating layer, i.e. the projections can be stretched or compressed along the perpendicular axis to achieve anisotropic wall thickness. Anisotropic projections within the plane can be realized, for example by using the curve offsetting method based on a modified medial axis as described in [PF10].

The next step in the construction of the inner hull contours in each deposition layer (subsequently called the “receiving” layer), is the forming of the 2D Boolean union of all offset projections penetrating it from surrounding layers, as well as the horizontal projection generated in the receiving layer itself. The Boolean intersection of the resulting union with the area enclosed by the outer hull contours then defines the wall cross-sections in 2D. They are delimited by the outer hull contours on one side and the sought inner hull contours on the other.

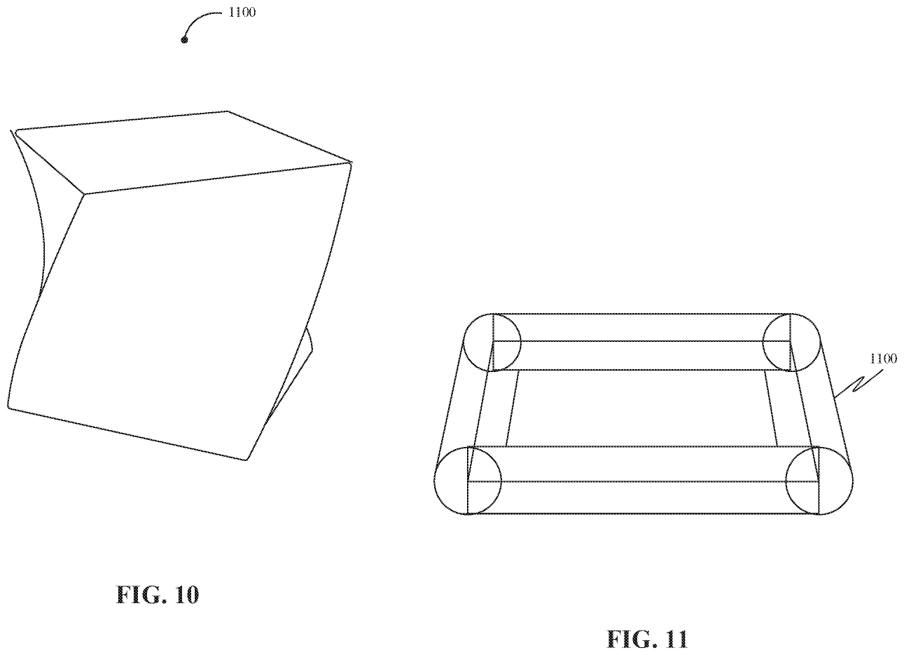

FIG. 10 is a representation of a simple object 1000, a twisted cube, which provides a basic exemplary shape, in accordance with some embodiments.

FIG. 11 is an outer hull contour 1100 at an arbitrary horizontal cross-section (layer) of the simple object 1000, and a conceptual toroidal projection generated around the simple object 1000, in accordance with some embodiments.

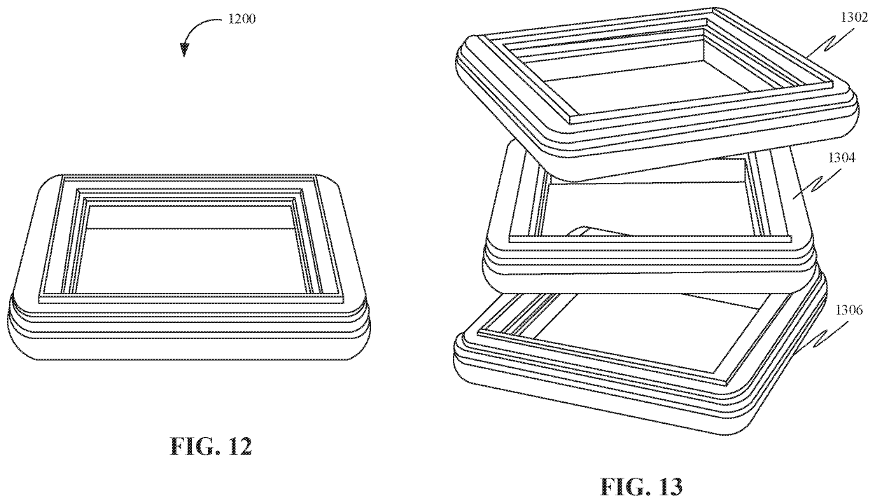

FIG. 12 is a representation of an ideal geometric shape 1200 of the toroidal projection of the simple object 1000, converted into slices coinciding with the layers of material deposition, in accordance with some embodiments.

FIG. 13 shows three sliced layers, including a first layer 1302, a second layer 1304, and a third layer 1306 with the projections around outer hull contours, in accordance with some embodiments.

FIG. 14 is a representation of a successively denser set of superimposed projections 1400 forming a shape of shape an inner hull of the simple object 1000, in accordance with some embodiments.

FIG. 15 is a representation of projections of a top face 1502, and a bottom face 1504 of the simple object 1000 (twisted cube) in accordance with some embodiments.

Further, the projections of top face 1502, and the bottom face 1504 may be are to be added to projections of the outer hull contours.

FIG. 11 through FIG. 15 illustrate this process using the shape of a twisted cube shown in FIG. 10. FIG. 11 shows the ideal toroidal projection around the outer hull contour of a single layer, with the spherical shape of individual point projections visible in the corners of the square. FIG. 12 shows this idealized shape sliced according to the deposition layers; in FIG. 13 and FIG. 14 the twisted cube takes shape by superimposing the offset projections from more and more generating layers, and FIG. 15 shows the caps at the top and bottom which project the walls for the sides of the cube which are parallel to the plane of deposition. The final two steps, the Boolean intersection with the shape enclosed by the outer hull, and the tracing of the inner hull contour, are omitted from this 3D illustration.

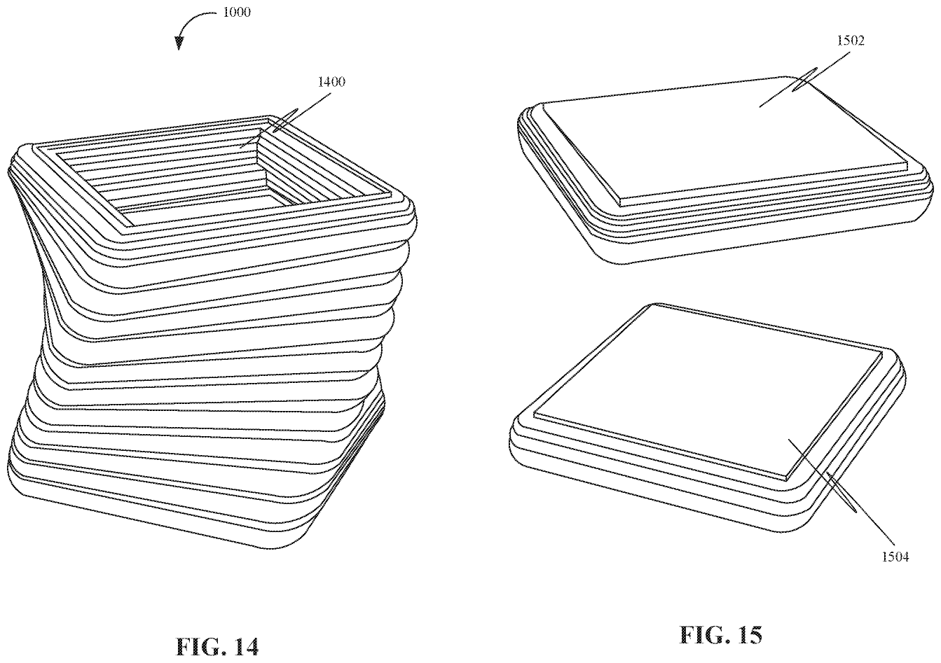

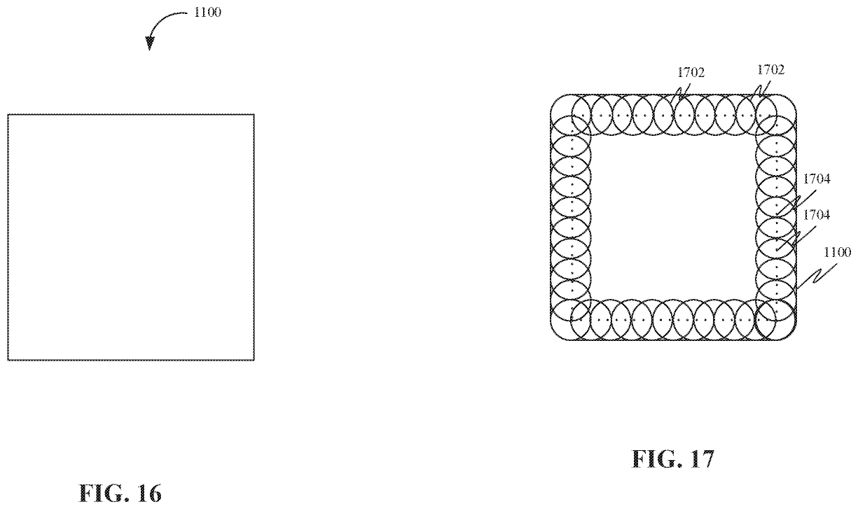

FIG. 16 is a depiction of the outer hull contour 1100 of a single layer of the simple object 1000, in accordance with some embodiments.

FIG. 17 is an illustration of forming of a Boolean union of a plurality of spherical projections 1702 centered on a plurality of points 1704 on the outer hull contour 1100 through their sliced contours, which may be circular, in accordance with some embodiments.

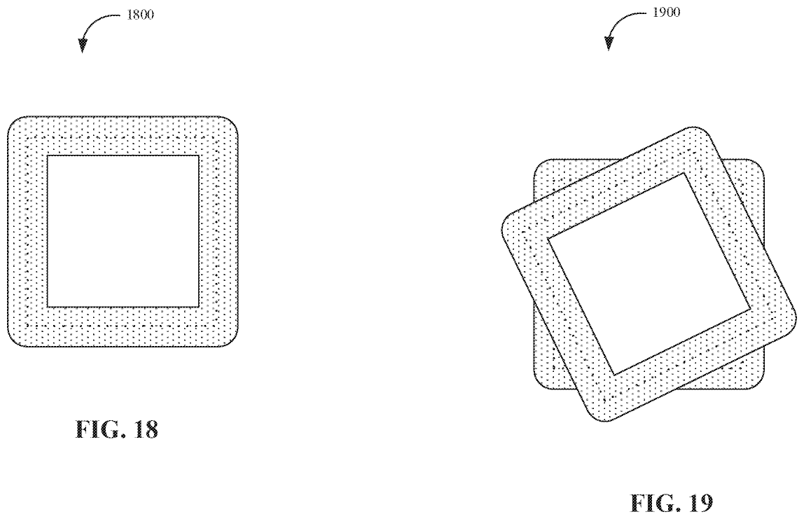

FIG. 18 is a completed Boolean union 1800 of the plurality of spherical projections, in accordance with some embodiments. Further, only the parts inside the outer hull of the simple object 1000 may actually contribute to an inner hull.

FIG. 19 is a representation of a superposition 1900 of a projection from a neighboring layer, in accordance with some embodiments. Further, a twist angle may be exaggerated, so that the principle of the operations may be more visible and may be better explained.

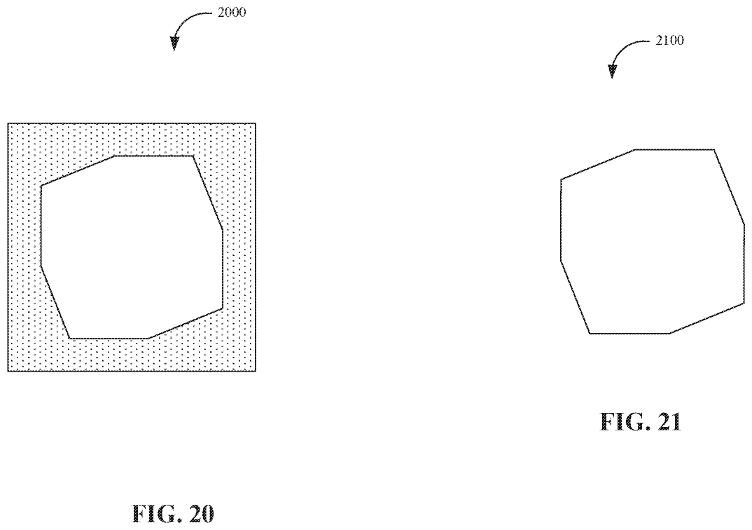

FIG. 20 is a cross-section of a wall 2000 that may result from a Boolean intersection of the superposition 1900 enclosed by the outer hull contour, in accordance with some embodiments. Further, any material projecting outside the outer hull may be removed.

FIG. 21 is a resulting inner hull contour 2100 derived from the cross-section of the wall 2000, in accordance with some embodiments.

The complete sequence of steps is demonstrated for a single 2D layer in FIG. 16 through FIG. 21. Starting with the outer hull contour in FIG. 16, the spherical projections are shown in FIG. 17, and their union is formed in FIG. 18 (FIG. 17 only illustrates the geometric process of forming the union; no actual circular projections are actually processed). In FIG. 19 the projection from a neighboring layer is superimposed by forming the Boolean union of the two layers (the twist angle is exaggerated in the drawings in order to be easier to recognize). Material outside the outer hull boundary is removed by forming the Boolean intersection with that hull in FIG. 20, and finally in FIG. 21 the inner hull contour is obtained. The method described so far constitutes a very efficient way of hollowing arbitrary 3D shapes to a defined wall thickness, either a uniform across the entire object surface or locally varying. Under certain conditions which will be described below, the method can be further simplified in the following preferred embodiment, so that only the inner half of each pair of offset projection contours needs to be processed, which further reduces the computational burden significantly.

The outer sliced contours in the projection layers will, by definition, not contribute to the inner hull. If the Boolean union of the projections in the receiving layer is formed by overlaying filled areas, however, they are needed to define the coverage areas.

If, on the other hand, the offset projections for each layer have a constant vertical reach throughout each layer (this reach can be different between layers, and even different above and below the generating plane), then the inner contours of the union, i.e. the sought inner hull of the hollowed object, can be determined directly using winding numbers, in a process analogous to [GH98] and described in detail in the next paragraph.

If the distance of the receiving layer from the top or bottom of the object is within the desired wall thickness, then the receiving layer is a solid layer, i.e. there is no inner hull in that layer and the wall fills the entire area enclosed by the outer hull trace. Otherwise, the projected offset contours from all contributing layers are superimposed in the receiving layer, and the number of contributing layers is noted. It is not necessary to identify surface areas that are near-parallel to the layer of deposition (plateaus), as the winding number logic will produce the correct results for these areas automatically.

By convention, contour traces are considered to be oriented in such a way in the 2D plane that the inside of the traced object is to the left of the trace going forward, i.e. the outermost trace of a slice through an object has counter-clockwise orientation. The orientation of the offset curves should follow the same rule, in order for each pair of concentric offset curves to delimit a common wall. This means that the outer offset curve should have the same orientation as the generating outer hull contour, and the orientation of the inner offset curve should be opposite, i.e. it should be clockwise for a counter-clockwise generating contour and vice versa.

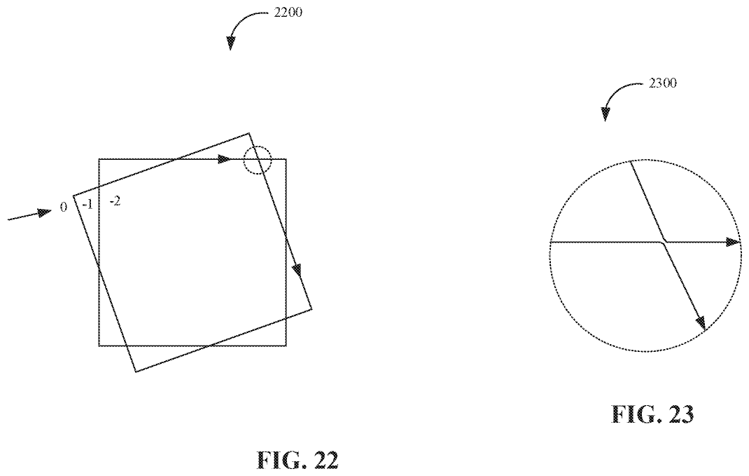

FIG. 22 is a representation of a superimposition 2200 of oriented inner projection contours and computing winding numbers with an intersection of two contours enlarged for generating an inner hull, in accordance with some embodiments.

FIG. 23 is a representation of an enlarged view 2300 of the superimposition 2200, after resolution of the intersection, in accordance with some embodiments. Further, a gap shown in place of the intersection that has been resolved should be considered as infinitesimally small).

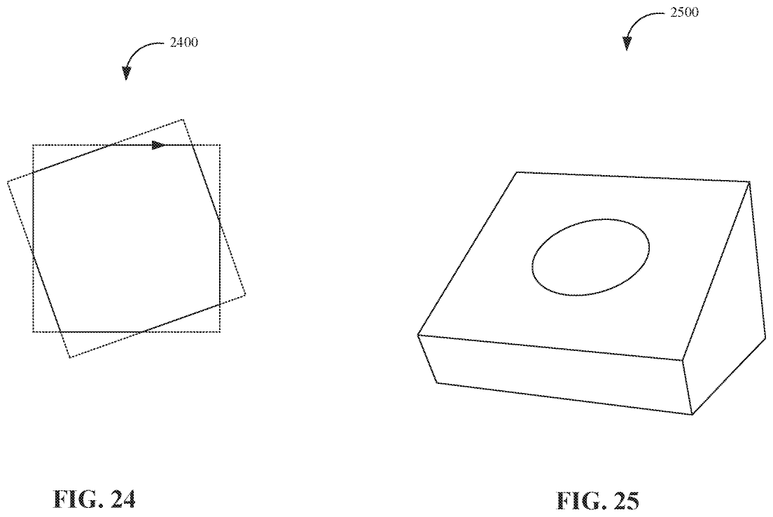

FIG. 24 is a representation of an inner hull 2400 the superimposition 2200, in accordance with some embodiments.

All intersections are resolved by cutting the intersecting lines at the intersection point and reconnecting the pieces in such a way that they turn away from the intersection. The result of this process is a new set of contours which no longer intersect. This reconnection is illustrated in FIG. 23, with the conceptually infinitesimally small gap at the former intersection point shown large enough to be visible. The winding numbers of all resulting non-intersecting loops are determined, and the inner hull contour is formed by those loops whose winding number is equal to the negated number of contributing layers. In the example of FIG. 22, the winding number 151 of the sought inner hull contour is equal to −2, as there are two contours being superimposed. FIG. 24 shows the resulting inner hull contour which has the same shape as that constructed in the previous example in FIG. 16 through FIG. 21.

The correctness of the described implementation relies on the exact preservation of the topological relationships of all intersection points with respect to all contours. This is difficult to obtain with ordinary floating-point arithmetic, due to rounding errors in the calculations. However, this is a general problem in computational geometry, for which a number of solutions has been developed in the literature. Among the possible remedies are the use of exact arithmetic [B99], or the representation of all end points of polyline segments as integer coordinates, paired with the use of rational numbers (integer fractions) for the computed intersection points.

FIG. 25 is a vertical cross-section of an object 2500 to illustrate the forming of a wall of uniform thickness around a concave region of the hull, by superposition of semi-toroidal projections, in accordance with some embodiments.

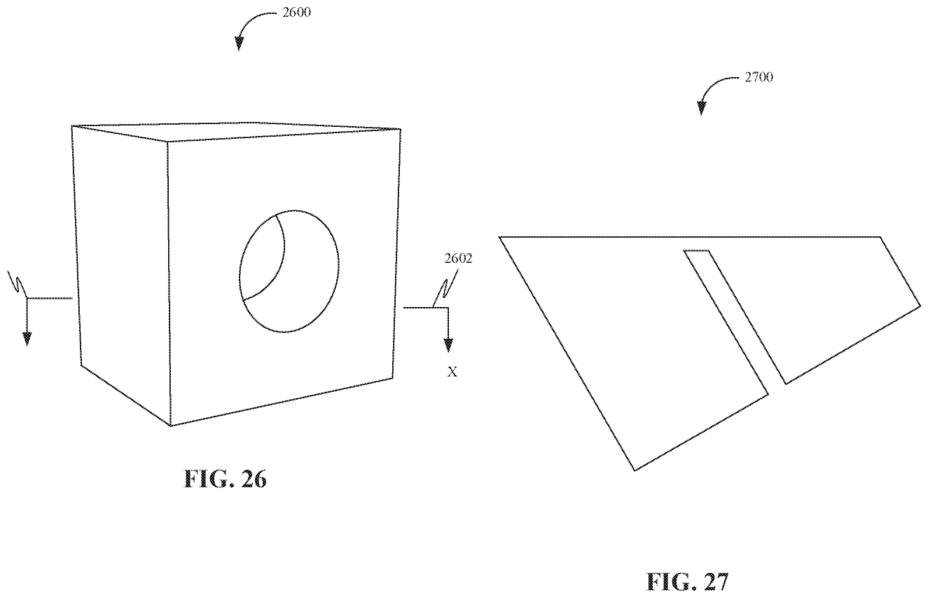

FIG. 26 is an exemplary offset projection profile 2600 to produce uniform or variable wall thickness, in accordance with some embodiments.

FIG. 27 is a complex object 2700, in accordance with some embodiments.

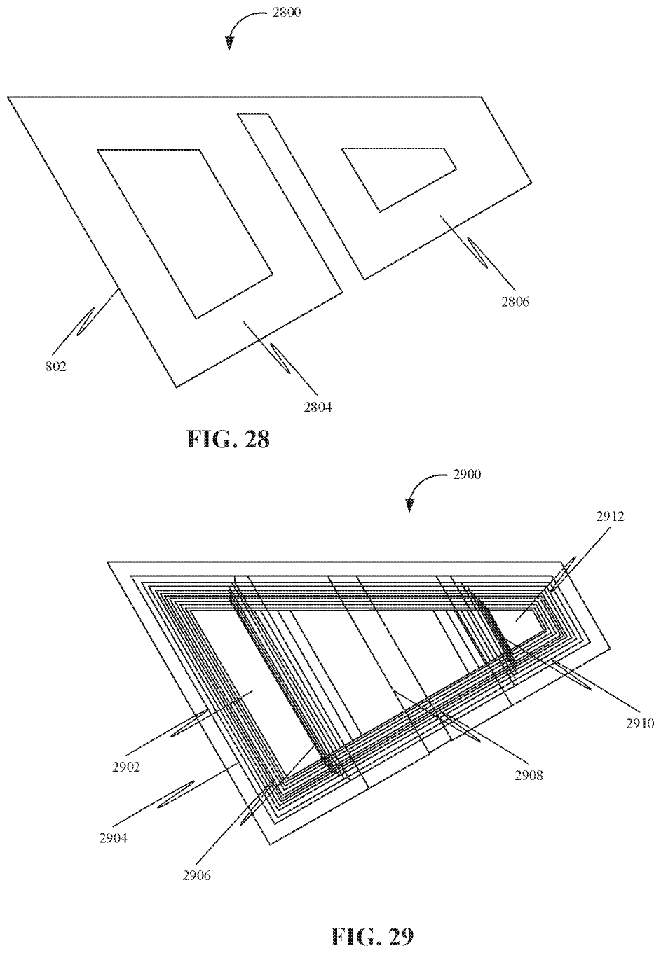

FIG. 28 is a second orientation of the complex object 2800, in accordance with some embodiments. Further, during simplified hollowing, line 2602 may indicate vertical position of the cross-section in FIG. 29-FIG. 32.

FIG. 29 is an outer hull trace 2900 of the object 2700 at a vertical level, in accordance with some embodiments.

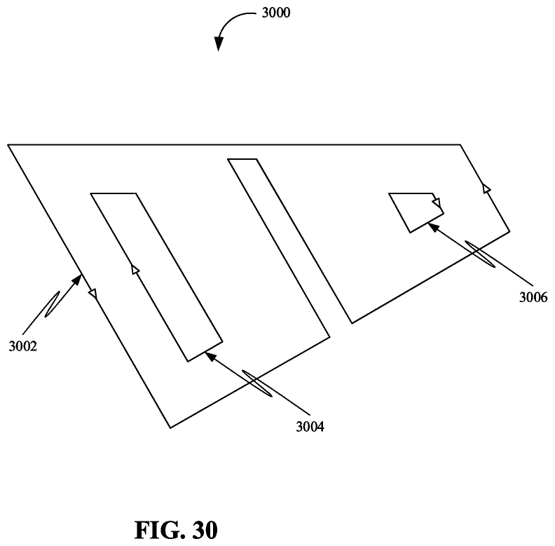

FIG. 30 is a representation of an inward offset 3000 of the outer hull 2900 trace at a constant offset distance, in accordance with some embodiments. Specifically, FIG. 30 shows the contours 3004 and 3006 of the constructed inner hull as well as the outer hull 3002, each with its orientation. When comparing FIG. 30 with FIG. 28, one can see that a uniform wall thickness in 3D implies non-uniform wall offsets in the 2D layers.

FIG. 27 through FIG. 30 show this method applied to one layer of the object depicted in FIG. 25. FIG. 26 shows that same object in the orientation in which it will be build, with line X indicating the layer of interest. This layer intersects the central cavity of the object near its lower cusp, where the horizontal cross-section of a wall of uniform thickness around the cavity is much wider that the horizontal cross-section of the near-vertical walls.

FIG. 27 shows the outer hull trace of the layer of interest. FIG. 28 adds the horizontal, in-layer, offsets 2802-2804 to the outer hull trace 2806. FIG. 29 shows the input into the superposition step: it shows the outer hull contour 2908 as well as all projected offset curves from the layer of interest as well as the surrounding layers within a distance of one wall thickness. Projected offsets originating from the boundary of the central cavity (regions 2906 and 2910) extend much further than offsets in region 2904 from near-vertical wall sections. The pattern of the offset lines in regions 2906 and 2910 shows that they originated from a curved surface. The outlines of regions 2902 and 2912 comprise the sought inner hull of the layer of interest.

In some 3D printing systems, the speed at which material can be deposited is inversely related to printing resolution, in which case deposition typically occurs at a high resolution on the outside of an object being printed, and at a lower resolution (and thus faster) towards the inside, where the roughness resulting from the lower resolution is not visible. In such a case the number of offset projections computed and the number of superpositions performed in the construction of the inner hull can be reduced to match the inner vertical resolution of the deposition of material.

Similarly, the number of distinct offset curves to be computed for each generating trace can be reduced depending on the tolerance requirements for the inner hull, because the offset distances for layers in close proximity are nearly identical for layers close to the generating layer (where the surface of the projections is nearly perpendicular to the generating layer).

Likewise, there may be cases in which the desired wall thickness depends of the local inclination of the wall with respect to the build surface. For example, the user may want vertical walls to be stronger (or lighter and hence weaker) than horizontal ones. Such variations can be obtained by using a radial projection profile that is not circular, but one that emphasizes certain directions.

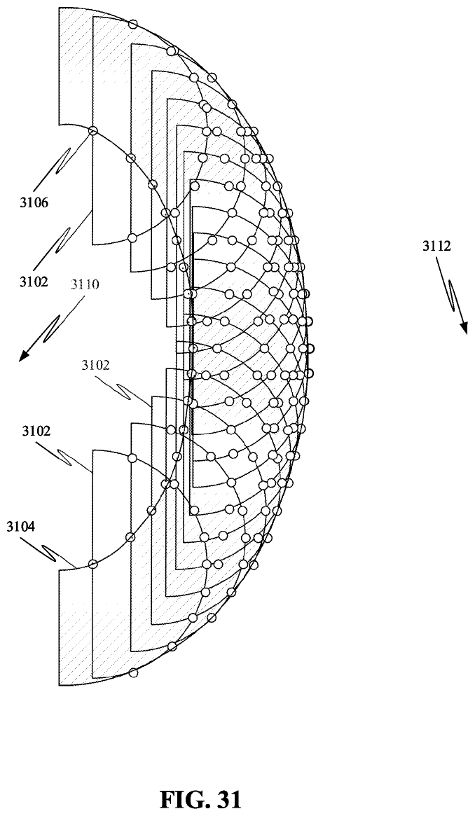

FIG. 31 is a representation of a plurality of projected offsets 3102 from surrounding layers superimposed on the inward offset 2900, in accordance with some embodiments.

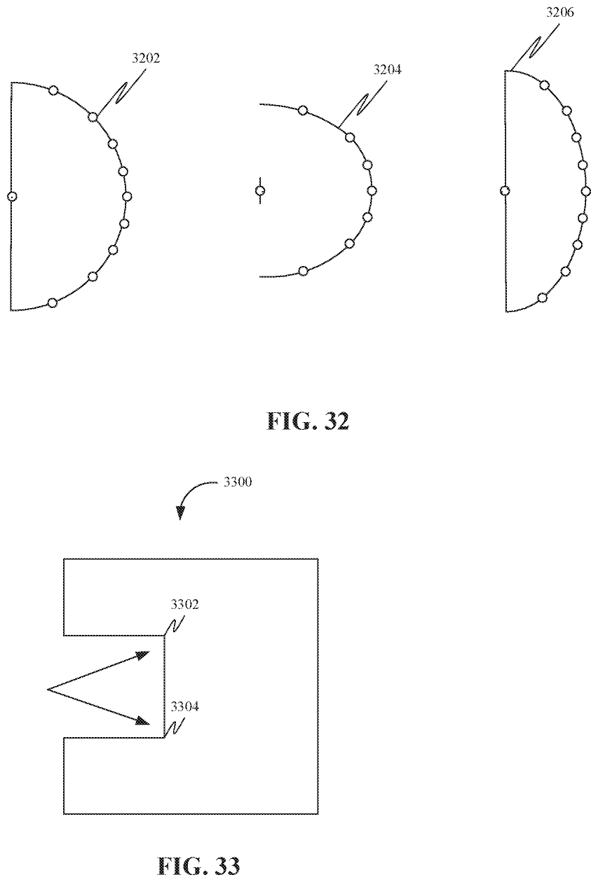

FIG. 32 is a representation of the outer hull and a plurality of profiles, including a circular profile 3202, a first elliptical profile 3204, and a second elliptical profile 3206 of the computed inner hull of the object 2700, in accordance with some embodiments.

FIG. 31 shows a vertical cut through a concave section of the hull 3104 of an object. Each contour trace 3106 may be a center point of a hemi-torus 3108 of offsets projected onto the layers above and below. For each projection, only the slices contour that point to the inside 3112 of the object take part, while those pointing to the outside 3110 are ignored. The inner hull is then formed by the innermost projection in each layer, i.e. the projection furthest from the outer hull in the receiving layer. Where FIG. 31 uses spherical projections, resulting in uniform wall thickness, FIG. 32 gives two anisotropic examples in the form of elliptical profiles 3204 or 3206, which could be applied in place of the circular profile 3202 that was also shown in FIG. 31. The flat ellipse 3204 in this example would produce vertical walls that are thicker than horizontal ones, while the slender ellipse 3206 would have the opposite effect.

Further, the point 3106 may represent a sample point on a concave section of the hull 3104. Further, the sample point 3106 may form one or more rings in a layer, and may be projected radially upwards and downward, so that the one or more rings may be at the center of toroidal shapes. Conceptually, those toroidal shapes may be sliced again, and a 2D Boolean union of the slicing results may be formed. In an embodiment, no slicing of tori may place. Alternately, projections may be formed by horizontal projection with a reduced distance, and then translated to an upward or downward layer.

Walls with locally varying thickness can also be constructed, for example to reinforce areas that will be subjected to high mechanical stress. Such areas can be identified manually by the user; or programmatically via detailed mechanical analysis, e.g. finite element analysis; or an automated process can apply heuristics, e.g. reinforce all inward-facing creases of the hull, which can be detected using a method like that described in [PS02]. Likewise, the shape and size of the reinforcement can be determined manually or programmatically.

The 3D geometry of the reinforcement is then sliced at the same layers as the object to be reinforced. In each layer penetrated by the reinforcement, the Boolean union of the resulting slice with the already created wall structure is then formed; and the Boolean intersection of the resulting shape with the shape enclosed by the outer hull is taken. Alternatively, applying the simplified technique illustrated in FIG. 22 through 31, the contours of the reinforcement are superimposed on the contours of the inner hull, intersections are resolved as described above, and the loops with a winding number of -1 (the same as the inner hull loops at the beginning of the superposition), constitute the new contours of the reinforced inner hull.

FIG. 33 is a representation of a layer 3300 of an object along with a stress points that may need to be reinforced, in accordance with some embodiments. The object may be a cube with a notch cut into it, with two concave corners, including a first corner 3302, and a second corner 3304 of the notch may be reinforced.

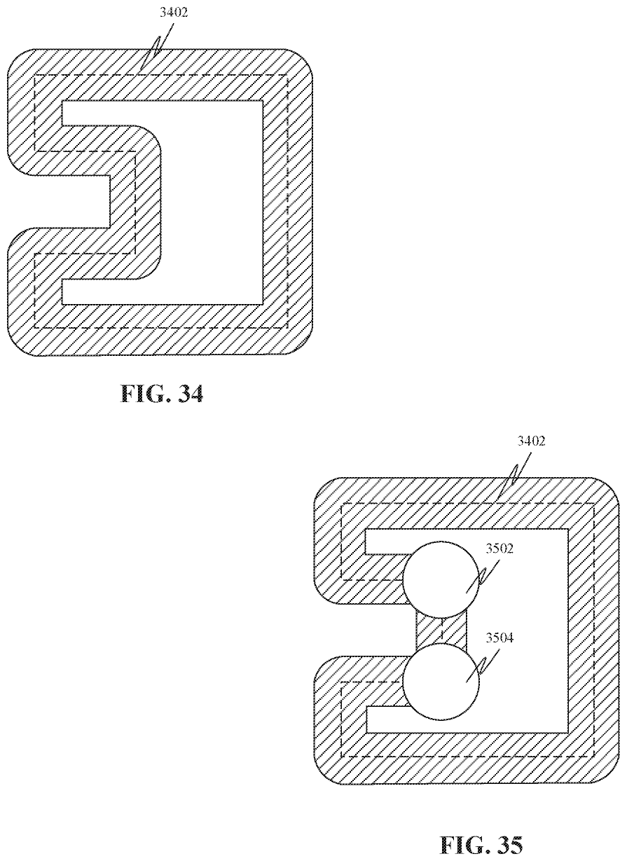

FIG. 34 is a representation of an initial wall offset projections 3402 in the layer 3300, in accordance with some embodiments.

FIG. 35 is a representation of a plurality of slices (including a first slice 3502 and a second slice 3504) and of a reinforcement material superimposed on the initial wall offset projections 3402, in accordance with some embodiments.

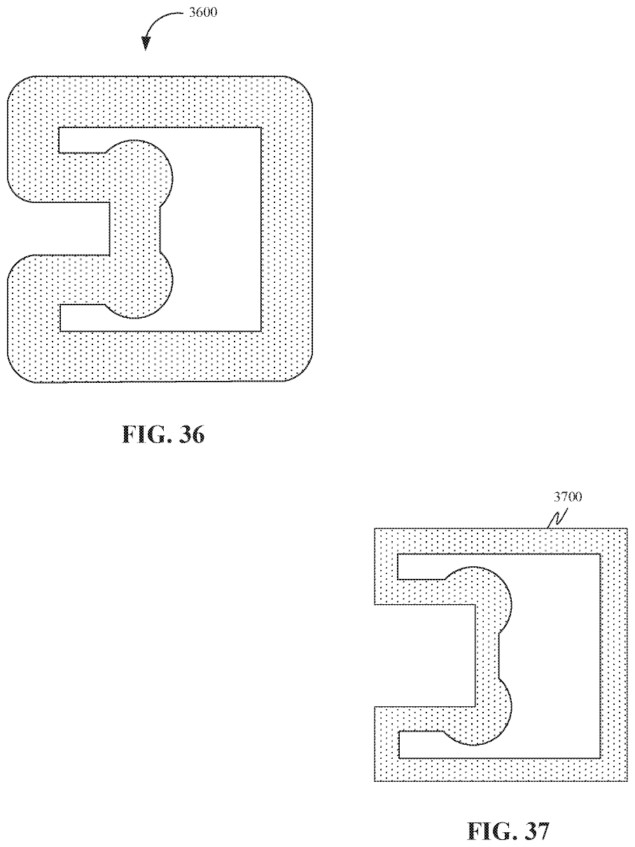

FIG. 36 is a representation of a Boolean union 3600 of the plurality of slices and the initial wall offset projections 3402, in accordance with some embodiments.

FIG. 37 is a representation of a wall resulting from the Boolean intersection 3600, in accordance with some embodiments.

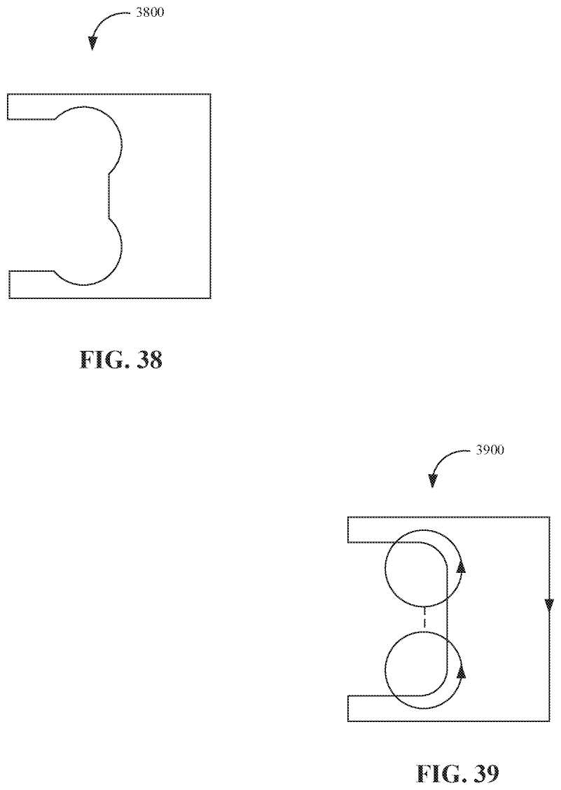

FIG. 38 is an inner hull contour 3800 derived from the wall resulting from the Boolean intersection 3600, in accordance with some embodiments.

FIG. 39 is an inner hull contour 3900 derived using the simplified wall projection method in accordance with some embodiments. Further, oriented contours of the sliced reinforcement beads may be superimposed.

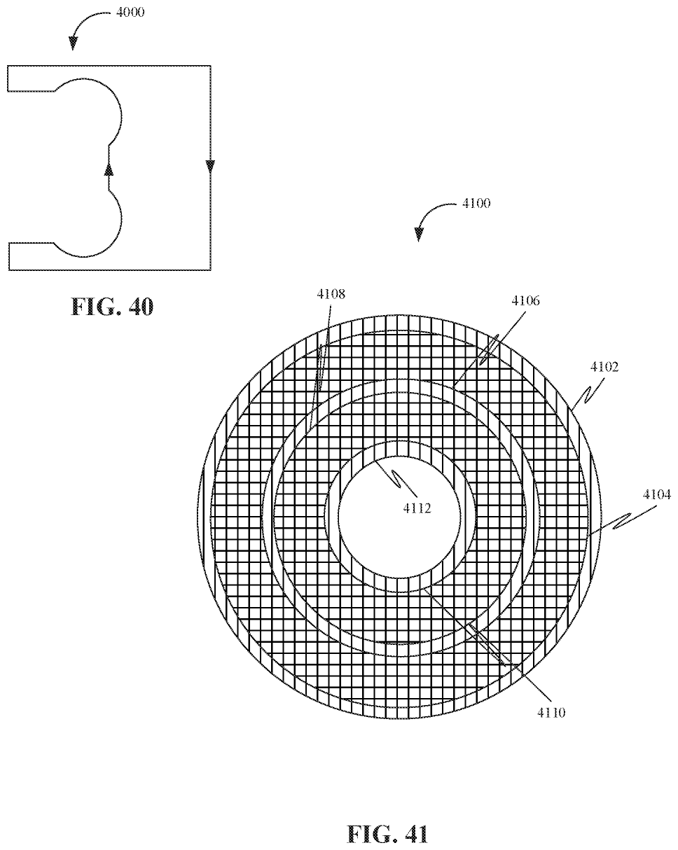

FIG. 40 is a reinforcement 4000 using simplified hollowing method, in accordance with some embodiments.

FIG. 41 illustrates how a multi-layered (sandwiched) wall 4100 may be constructed, in accordance with some embodiments. Further, spaces between adjacent pairs of concentric hull surfaces may be alternately filled with solid material and lighter infill.

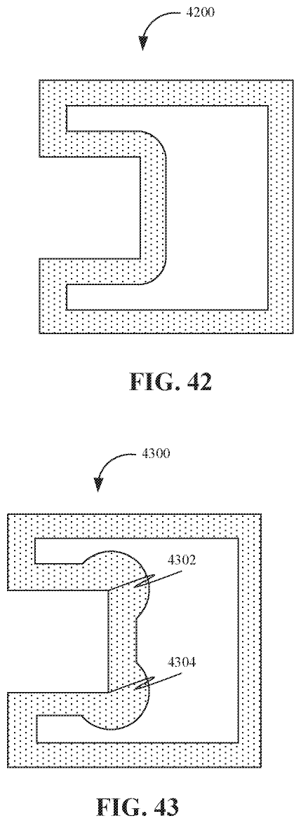

FIG. 42 shows a layer 4200, hollowed three times, with the spaces between the concentric hulls filled, in sequence, with solid material, light-weight lattice structure, and again with solid material, in accordance with some embodiments.

FIG. 43 shows a layer 4300 hollowed three times to produce a sandwiched wall structure along with identification of two stress points (first stress point 4302, and second stress point 4304) having reinforced, in accordance with some embodiments.

FIG. 33 through 38 illustrate the process of wall reinforcement. FIG. 33 shows a layer 3300 of an object (a cube with a notch cut into it), with two corners, including a first point 3302 and a second point 3304, to be reinforced pointed out. FIG. 34 shows the wall offset projections 3402 without reinforcement. A bead of reinforcing material is then sliced, and the resulting cross-sections are superimposed on the layer by forming the Boolean union with the previously formed offset projections (see FIGS. 35 and 36). The Boolean intersection of the compound shape with the space enclosed by the outer hull, analogous to FIG. 13, then results in the cross-section of the wall in FIG. 37, from which the inner hull contour in FIG. 38 is derived.

In this example the cross-section of the reinforcement beads appears circular as a consequence of the simple cylindrical 3D shape of the bead and its vertical orientation; other bead shapes, other orientations, reinforcements along a curved path, etc., will create 2D slices of different shapes. The reinforcement can take any shape suggested by mechanical analysis, and the shape depicted in FIG. 35 through 40 was chosen for illustrative purposes only.

FIGS. 39 and 40 demonstrate how the simplified wall offsetting method using winding numbers, illustrated in FIG. 22 through 24, can be applied to achieve the same result. FIG. 39 shows the initial oriented inner hull contour, with the oriented slices of the reinforcement beads superimposed. Using the same intersection resolution method described above and illustrated in FIG. 22 and FIG. 23, one obtains the reinforced inner hull contour shown in FIG. 40, whose shape is the same as that in FIG. 38.

The invention can also be used to create walls consisting of sandwiched layers of defined thickness, by combining inner hulls using multiple wall thicknesses. If the same offset projection shape is used, but at different scales, then these inner hulls will be concentric, and the spaces between them will have a constant distance. The spaces can then be filled with infill structures, such as lattices or origami-like folding structures, resulting in light-weight but high-strength walls. An example of a cross-section of such a sandwiched wall is shown in FIG. 41, where outer hull is offset five times to form inner hulls and the spaces between these hulls are alternately filled with solid material and a low-density lattice.

The methods for reinforcement and for constructing sandwiched walls described above can be combined to produce reinforced structured walls. In this case each inner hull is constructed separately, and the reinforcement is scaled according to the individual inner hull before being combined with it as described above. The spaces between the resulting concentric reinforced hulls are then filled with solid material or infill as appropriate.

As an example of this combined process, FIG. 42 shows a layer of the notched cube used as an example above (cf. FIG. 33). Three concentric inner hulls have been constructed, and the spaces between them filled. The outer hull and the first inner hull delimit a solid wall between them, as do the second and third inner hull. The space between the first and second inner hull is filled with a light-weight lattice structure. FIG. 43 shows the same layer as FIG. 42, but in addition the two stress points identified in FIG. 33 have been reinforced. The end result in this example is an overall wall structure with the same outer dimensions as that in FIG. 37, but the wall is now sandwiched. Once again, the reinforcement can take any shape suggested by mechanical analysis, and the shape depicted in FIG. 41 was chosen for illustrative purposes only.

According to some embodiments, a method for efficiently hollowing a given three-dimensional geometry to a defined, locally varying wall thickness, with the output consisting of outer and inner hull contours of the hollowed geometry in layers such as those used when producing objects using additive manufacturing, 3D printing, or rapid prototyping technologies is disclosed. The method transforms the 3-dimensional operations of projecting the wall offsets and forming their Boolean union into a sequence of 2-dimensional operations that is computationally more efficient.

Further, according to some embodiments, a method for efficiently hollowing a given three-dimensional geometry to a uniform wall thickness, with the output consisting of outer and inner hull contours of the hollowed geometry in parallel layers such as the layers used when producing objects using additive manufacturing, 3D printing, or rapid prototyping technologies is disclosed. The method consists of the superposition of hemi-toroidal offset projections from the target layer itself and all surrounding layers within a distance of one wall thickness. Further, realized wall thickness can be made to vary depending on the inclination of the walls with respect to the production layers. Further, wall thickness may vary as a function of the layer. Further a reinforcement (thickening) may be applied to selected areas of the walls. Further, solid walls may be created by completely filling the space between the outer and inner hull contours uniformly with material. Further, in some embodiments, sandwiched walls may be created, consisting of a layer of material at the outer and inner hull, each of a chosen thickness, with the space between them filled with a porous or lower-density lattice or folding structure. Further, each method disclosed herein may be applied multiple times to a same geometry, but with successively increasing offset distance, to create multi-layer sandwiched walls.

Further, according to some embodiments, a method for locally reinforcing (thickening) areas of the wall, applied to the creation of sandwiched walls is disclosed.

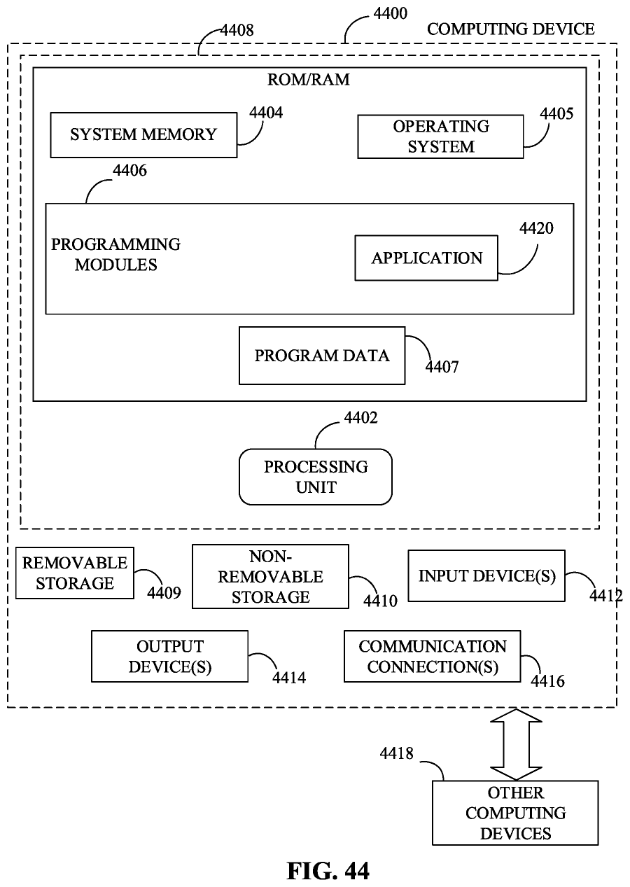

With reference to FIG. 44, a system consistent with an embodiment of the disclosure may include a computing device or cloud service, such as computing device 4400. In a basic configuration, computing device 4400 may include at least one processing unit 4402 and a system memory 4404. Depending on the configuration and type of computing device, system memory 4404 may comprise, but is not limited to, volatile (e.g. random-access memory (RAM)), non-volatile (e.g. read-only memory (ROM)), flash memory, or any combination. System memory 4404 may include operating system 4405, one or more programming modules 4406, and may include a program data 4407. Operating system 4405, for example, may be suitable for controlling computing device 4400′s operation. In one embodiment, programming modules 4406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 44 by those components within a dashed line 4408.

Computing device 4400 may have additional features or functionality. For example, computing device 4400 may also include additional data storage devices (removable and/or non-removable) such as, for example, magnetic disks, optical disks, or tape. Such additional storage is illustrated in FIG. 44 by a removable storage 4409 and a non-removable storage 4410. Computer storage media may include volatile and non-volatile, removable and non-removable media implemented in any method or technology for storage of information, such as computer-readable instructions, data structures, program modules, or other data. System memory 4404, removable storage 4409, and non-removable storage 4410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4400. Any such computer storage media may be part of device 4400. Computing device 4400 may also have input device(s) 4412 such as a keyboard, a mouse, a pen, a sound input device, a touch input device, a location sensor, a camera, a biometric sensor, etc. Output device(s) 4414 such as a display, speakers, a printer, etc. may also be included. The aforementioned devices are examples and others may be used.

Computing device 4400 may also contain a communication connection 4416 that may allow device 4400 to communicate with other computing devices 4418, such as over a network in a distributed computing environment, for example, an intranet or the Internet. Communication connection 4416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 4404, including operating system 4405. While executing on processing unit 4402, programming modules 4406 (e.g., application 4420 such as a media player) may perform processes including, for example, one or more stages of methods, algorithms, systems, applications, servers, databases as described above. The aforementioned process is an example, and processing unit 4402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method for producing hollowed 3D shapes by layer comprising:
receiving, using a communication device, a contour information corresponding to a contour a 3D shape;
forming, using a processing device, a plurality of regular geometric shapes around a plurality of sample points corresponding to the contour;
forming, using the processing device, a plurality of projections corresponding to the plurality of regular geometric shapes onto a printing plane;
superimposing, using the processing device, the plurality of projections to obtain an effective inner contour corresponding to the contour of the 3D shape; and
transmitting, using the communication device, the effective inner contour to a construction device for constructing the shape.

2. The method for producing hollowed 3D shapes by layer as claimed in claim 1 comprising:
receiving, using the communication device, a geometrical data file corresponding to the 3D shape from a source; and
slicing, using the processing device, the 3D shape, wherein the slicing comprises analyzing the 3D shape to determine the contour.

3. The method for producing hollowed 3D shapes by layer as claimed in claim 1 comprising:
analyzing, using the processing device, the contour information corresponding to the contour to determine at least one unconstructible detail; and
removing, using the processing device, the at least one unconstructible detail to generate a clean contour information corresponding to the contour.

4. The method for producing hollowed 3D shapes by layer as claimed in claim 1, wherein a dimension of the plurality of regular geometric shapes corresponds to a thickness parameter of the 3D shape.

5. The method for producing hollowed 3D shapes by layer as claimed in claim 1, wherein the plurality of regular geometric shapes comprises 3D globular shapes.

6. The method for producing hollowed 3D shapes by layer as claimed in claim 1, wherein the construction device comprises a 3D printer, wherein the plurality of regular geometric shapes corresponds to the printing plane.

7. The method for producing hollowed 3D shapes by layer as claimed in claim 1, wherein a dimension of the plurality of regular geometric shapes is configured to accommodate a varying thickness parameter of the 3D shape.

8. The method for producing hollowed 3D shapes by layer as claimed in claim 1 comprising:
analyzing, using the processing device, the contour information to determine at least one stress point; and
increasing, using the processing device, a dimension of at least one regular geometric shape corresponding to at least one sample point corresponding to the at least one stress point.

9. A method for producing hollowed 3D shapes by layer comprising:
receiving, using a communication device, a geometrical data file corresponding to a 3D shape to be printed from a source;
slicing, using a processing device, the 3D shape, wherein the slicing comprises analyzing the 3D shape to determine a contour;
forming, using the processing device, a plurality of regular geometric shapes around a plurality of sample points corresponding to the contour;
forming, using the processing device, a Boolean union of a plurality of projections corresponding to the plurality of regular geometric shapes onto a printing plane to obtain a shape corresponding to an inner contour;
superimposing, using the processing device, the shape to obtain an effective inner contour corresponding to the contour of the 3D shape, wherein the superimposing comprises forming a Boolean union of the shape; and
transmitting, using the communication device, the effective inner contour to a construction device for constructing the 3D shape.

10. A system for producing hollowed 3D shapes by layer comprising:
a communication device configured for:
receiving a contour information corresponding to a contour of a 3D shape; and
transmitting an effective inner contour to a construction device for constructing the shape;
a processing device configured for:
forming a plurality of regular geometric shapes around a plurality of sample points corresponding to the contour;
forming a plurality of projections corresponding to the plurality of regular geometric shapes onto the printing plane; and
superimposing the plurality of projections and the plurality of projections to obtain the effective inner contour corresponding to the contour of the 3D shape.

11. The system for producing hollowed 3D shapes by layer as claimed in claim 10, wherein the communication device is configured for receiving a geometrical data file corresponding to the 3D shape from a source, wherein the processing device is further configured for slicing the 3D shape, wherein the slicing comprises analyzing the 3D shape to determine the contour.

12. The system for producing hollowed 3D shapes by layer as claimed in claim 10, wherein the processing device is further configured for:
analyzing the contour information corresponding to the contour to determine at least one unconstructible detail; and
removing the at least one unconstructible detail to generate a clean contour information corresponding to the contour.

13. The system for producing hollowed 3D shapes by layer as claimed in claim 10, wherein a dimension of the plurality of regular geometric shapes corresponds to a thickness parameter of the 3D shape.

14. The system for producing hollowed 3D shapes by layer as claimed in claim 10, wherein the processing device is configured for:
defining a thickness parameter corresponding to each of the contour and the effective inner contour; and
generating at least one infill structure corresponding to an empty space between each of the contour and the effective inner contour; and
the communication device is further configured for transmitting each of the thickness parameter, and the at least one infill structure to the construction device.

15. The system for producing hollowed 3D shapes by layer as claimed in claim 14, wherein the processing device is configured for:
obtaining a plurality of effective inner contours congruent with the effective inner contour;
defining a thickness parameter corresponding to each of the contour and the plurality of effective inner contours; and
generating at least one infill structure corresponding to an empty space between each of the plurality of effective inner contours; and
the communication device is further configured for transmitting each of the effective inner contours, the thickness parameter corresponding to each of the contour and the plurality of effective inner contours, and the at least one infill structure to the construction device.

16. The system for producing hollowed 3D shapes by layer as claimed in claim 11, wherein a dimension of the plurality of regular geometric shapes is configured to accommodate a varying thickness parameter of the 3D shape.

17. The system for producing hollowed 3D shapes by layer as claimed in claim 11, wherein the processing device is further configured for:
analyzing the contour information to determine at least one stress point; and
increasing a dimension of at least one regular geometric shape corresponding to at least one sample point corresponding to the at least one stress point.

18. The system for producing hollowed 3D shapes by layer as claimed in claim 11, wherein the processing device is further configured for:
slicing the 3D shape, wherein the slicing comprises analyzing the 3D shape to determine a contour;
forming a Boolean union of the plurality of projections corresponding to the plurality of regular geometric shapes onto the printing plane to obtain a shape corresponding to an inner contour; and
superimposing, using the processing device, the shape to obtain the effective inner contour corresponding to the contour of the 3D shape, wherein the superimposing comprises forming a Boolean union of the shape.
